(19) United States
(12) Patent Application Publication
(10) Pub. No.: US 2004/0206581 A1
(43) Pub. Date: Oct. 21, 2004

(54) Sill shield

(76) Inventor: Matthew D. Baumann, Chicago, IL (US)

Correspondence Address: WELSH & KATZ, LTD, 120 S RIVERSIDE PLAZA, 22ND FLOOR, CHICAGO, IL, 60606, US

(21) Appl. No.: 10/417,050

(22) Filed: Apr. 16, 2003

(51) Int. Cl. B66B 13/02; E05F 17/00

(52) U.S. Cl. 187/313; 49/120

(57) ABSTRACT

A device for shielding elevator sills includes a rectangular body divided into top and bottom portions with a depression running the width of the body and defining the separate portions. The device includes a plurality of mounting slots located on the top portion of the shield.

### BACKGROUND OF THE INVENTION

The present invention is directed to an elevator sill shield device. More particularly, the present invention pertains to an elevator sill shield device having mounting slots and a depression allowing it to bend.

Elevator entrances and car door sills are vulnerable to dust, dirt and debris accretion. Elevator hoist ropes have a hemp core that is lubricated with oil. As the hoist ropes travel over drive sheaves, oil is forced out to the surface of the ropes. As the ropes travel through the hoistway (see FIG. 1 for a diagram of a typical elevator system), dust and dirt naturally adhere to the ropes, and eventually become a thick, black, tar-like substance known as “tallow.”

Eventually, the tallow is excreted from the ropes on to the elevator's car top, or on to the elevator's entrance and car door sills. Other miscellaneous hoistway debris and dust also tends to settle on the elevator's car top or door sills.

When an elevator stops at a given floor and its doors open, riders walking across the elevator's threshold may track tallow and/or other debris further into the building, dirtying and potentially damaging its floors.

Accordingly, there exists a need for a shield device to protect elevator car door sills and entrances from falling debris and hoist rope tallow. Such a shielding device not only greatly reduces the amount of housekeeping time spent clean elevator sills and hallway carpets and/or tiles, but also prevents debris from being re-tracked into the elevator cab. Most desirably, the shielding device is cost-effective, adjustable, and easy to install, requiring no maintenance.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 illustrates a standard elevator system.

FIG. 2 illustrates a device for shielding elevator sills embodying the principles of the present invention.

FIG. 3 illustrates the device of FIG. 1 as installed.

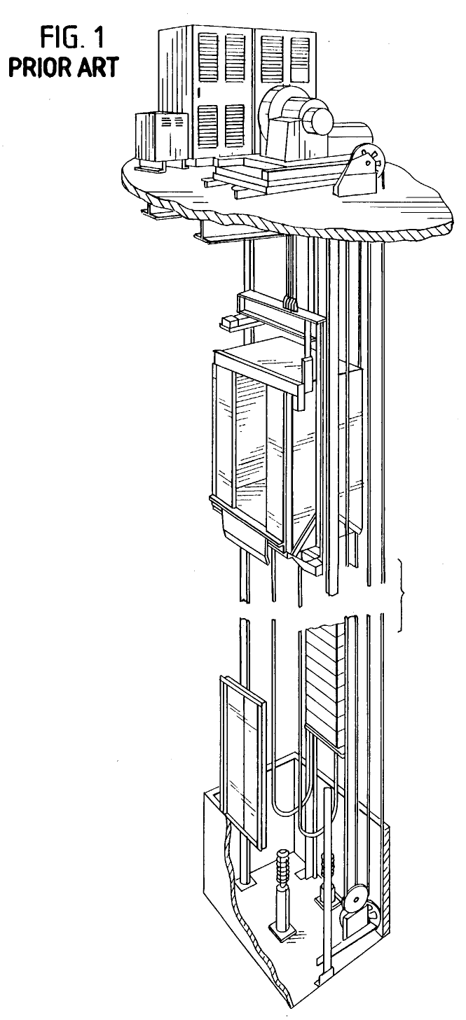

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

A device for use in shielding elevator sills includes a rectangular body divided into top and bottom portions. A depression runs the width of the body and defines the separate portions, allowing the device to bend between the top and bottom portions. A plurality of mounting slots are located on the top portion of the shield. Preferably, the shield is manufactured from eighteen-gauge aluminum.

In a preferred embodiment, the sides of the top portion of the shield are notched, so that the top portion is narrower than the bottom portion. Preferably, the notches measure approximately one inch by two inches, and are cut at a ninety-degree angle.

In the preferred embodiment, two mounting slots are provided. Preferably, the mounting slots measure approximately two inches by three-sixteenths of an inch. Most preferably, the mounting slots are located approximately two inches from the notched sides of the top portion.

In the preferred embodiment, the depression is formed approximately two inches from the top of the top portion of the shield.

These and other features and advantages of the present invention will be apparent from the following detailed description, in conjunction with the appended claims.

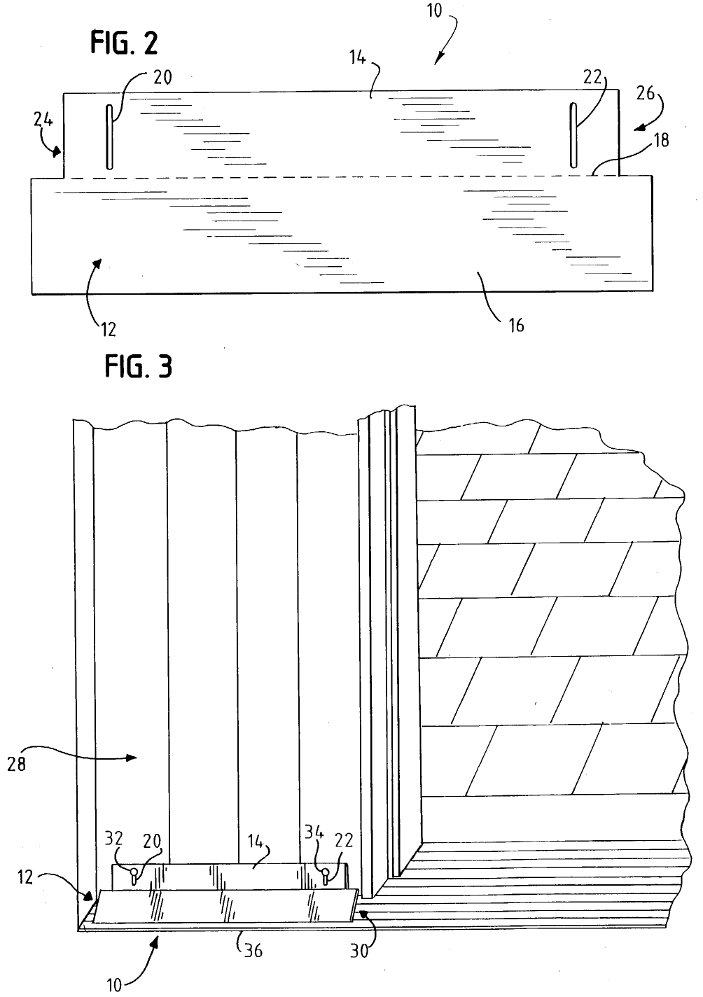

Referring to the figures and in particular FIG. 2, there is shown an elevator sill shield device 10 in accordance with the principles of the present invention. In a current embodiment, the device 10 is manufactured from eighteen-gauge aluminum. The shield device includes a rectangular body 12 divided into a top portion 14 and a bottom portion 16 by a depression 18 running the width of the body 12. In a preferred embodiment, two mounting slots 20, 22 are provided on the top portion 14.

Preferably, both sides 24, 26 of the top portion 14 are notched, rendering the top portion 14 narrower than the bottom portion 16. These notches 24, 26 allow the device 10 to be easily mounted around potential elevator door obstructions. Most preferably, the notches 24, 26 cut into the top portion 14 measure approximately one inch by two inches, and are cut at a ninety-degree angle.

In a preferred embodiment, each mounting slot 20, 22 is located approximately two inches from each notched side 24, 26 respectively. Preferably, each mounting slot measures approximately two inches by three-sixteenths of an inch. The relative length of the mounting slots 20, 22 allow the shield 10 to be adjusted either up or down as necessary, without removal.

The depression 18 preferably is provided approximately two inches from the top of the top portion 14 of the shield 10. The depression 18 allows for easy bending of the device 10, facilitating installation.

Referring now to FIG. 3, a preferable manner of shield 10 installation on the back side of an elevator hoistway door 28 is shown. The shield 10 is installed by first bending the body 12 to an angle at the depression 18. This initial bend facilitates installation and adjustment of the device 10. Next, the shield 10 is positioned approximately one-quarter of an inch above an elevator sill 30, and preferably attached with self-tapping screws 32, 34 inserted through the mounting slots 20, 22. The screws 32, 34 preferably are inserted approximately one-quarter of an inch from the top of the top portion 14 of the body 12, to allow for door guide service without shield 10 removal and to avoid shield 10 draggage.

After shield 10 installation, the bend angle is adjusted to provide proper sill 30 coverage while ensuring that the shield 10 does not extend past the sill line 36. The bottom portion 16 of the shield 10, which is installed at an angle, provides sill 30 protection from an edge of the elevator's sight guard to the back side of the elevator hoistway door 28.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An elevator sill shield device, comprising:
a rectangular body divided into a top portion and a bottom portion;
a depression running the width of the body and defining the top and bottom portions; and
a plurality of mounting slots located on the top portion.

2. The device in accordance with claim 1 wherein the device is formed of eighteen-gauge aluminum.

3. The device in accordance with claim 1 wherein the sides of the top portion are notched, rendering the top portion narrower than the bottom portion.

4. The device in accordance with claim 3 wherein the notches cut into the top portion measure approximately one inch by two inches.

5. The device in accordance with claim 3 wherein the notches are cut into the top portion at a ninety-degree angle.

6. The device in accordance with claim 3 wherein each mounting slot is located approximately two inches from each notched side of the top portion.

7. The device in accordance with claim 1 wherein the mounting slots measure approximately two inches by three-sixteenths of an inch.

8. The device in accordance with claim 1 wherein two mounting slots are provided on the top portion.

9. The device in accordance with claim 1 wherein the depression is located approximately two inches from the top of the top portion of the shield.
